(19) United States
(12) Patent Application Publication
(10) Pub. No.: US 2023/0028437 A1
(43) Pub. Date: Jan. 26, 2023

(54) GRIPPING DEVICE, ROBOT AND CONTROL METHOD

(71) Applicant: FRANKA EMIKA GmbH, München (DE)

(72) Inventors: Daniel Wahrmann LOCKHART, München (DE); Andreas SPENNINGER, Karlsfeld (DE); Jose Ramon Medina HERNANDEZ, München (DE); Christoph KUGLER, München (DE)

(21) Appl. No.: 17/787,914

(22) PCT Filed: Dec. 22, 2020
(86) PCT No.: PCT/EP2020/087717

§ 371 Date: Jun. 21, 2022

(30) Foreign Application Priority Data
Dec. 22, 2019 (DE) 10 2019 008 939.1

(51) Int. Cl. B25J 15/00; B25J 15/02; B25J 15/12

(52) U.S. Cl. CPC B25J 15/0028; B25J 15/026; B25J 15/12

(57) ABSTRACT

A gripping device for a robot for gripping objects, including at least two gripping units each having a gripping finger and being transferable by a controlled movement between a release position and a gripping position gripping an object, the gripping units each having gripper elements which, in the gripping position, can be brought into contact with the object to be gripped, in which the gripper elements are rotatably mounted on the gripping fingers of the gripping device.

### FIELD OF THE INVENTION

The present invention relates to a gripping device for gripping objects, in particular for robots and manipulators, a robot using the same, and a control method for gripping objects by means of a gripping device of a robot.

### BACKGROUND

Gripping devices as parallel grippers with two linearly movable grippers or finger elements, as centric grippers with at least three finger elements or as angular grippers with grippers that are clamped in an offset manner for robots are known in a wide variety of designs. The gripping devices can also be designed in such a way that they enable a linear or claw grip, in which an object is gripped by the grippers of the gripping device at only two individual points, or that they enable a grip that essentially completely encloses the object with the grippers or a spatial grip, in which the grippers or finger elements of the gripping device adapt to the contour of the object to be gripped, if necessary.

From WO 2013/075245 A1, for example, a gripping device is known which can be designed as a parallel or centric gripper, in which the grippers are designed as double arms, so as to realize a quasi-transmission or gear with a parallelogram guide. This makes it possible on the one hand to hold objects by a linear movement of the grippers towards each other, or on the other hand to grip curved objects in a partially enclosed manner by allowing the upper distal ends of the grippers to tilt around the object. Which type of gripping is ultimately used depends on the size and shape of the object to be gripped and the equilibrium plane between the finger elements that is established as a result of the design, i.e., the transmission. In principle, this enables flexible, adaptive gripping of the object, although the flexible and adaptive capabilities are considerably limited by the design. The mechanical design of the gear or transmission with lever elements, swivel joints, springs and actuators is complex and susceptible and also leads to a high weight of the entire gripping device.

A similar mechanical design for a gripping device is disclosed in WO 2016/141266 A1, where the lever elements of the fingers can be made monolithically from a flexible material, possibly with embedded tactile sensors.

Other gripping devices with a guide for the finger elements similar to a parallelogram gear are known, for example, from WO 2016/037288 A1 and from U.S. Pat. No. 9,533,419. The gripping device shown in the US patent also has finger elements in which the inner surfaces facing the object consist of a chain of individual links movable relative to one another, so that flexible gripping and gripping that can be adapted to the contour of the object to be gripped is permitted.

A gripping device is known from DE 10 2009 015 975 B4, in which the finger elements or grippers are designed as so-called fin beam elements with two flexurally flexible surfaces, the surfaces being connected to one another at their free ends and being fastened to a gripper base at a distance from one another to form a triangular arrangement. The two surfaces are connected to one another via a plurality of lamellae extending parallel to one another, each of which is resiliently connected to the surfaces at its end regions in an articulated or materially interlocking manner, so that when an object is gripped the surfaces conform to the surface of the object, since the surfaces are movable relative to one another via the lamellae. However, the flexible characteristics of such a gripping device are limited by design. In addition, for gripping, the finger elements must be actuated in their entirety and thus moved in a deformable manner, causing additional torques and forces to act on the mechanism.

However, none of the gripping devices described above is in itself capable of gripping a flat object that is filigree and, moreover, not rigid, in particular intrinsically flexible or elastic, such as fabrics, textiles, foils, paper or the like, so that the known gripping techniques in which the gripping fingers are moved vertically downwards over the object and then laterally (parallel grip) are not suitable. Intrinsic elasticity of such gripping devices as previously described, if present at all, is only designed for this type of parallel grip. However, this type of gripping usually fails with flat, soft objects, since a section of the object that is present above the parallel approaching fingers cannot be securely grasped by them. In addition, there is the problem that when the gripping fingers move in parallel, when they rest on the flat, flexible objects with their front ends, the objects in themselves are displaced, but cannot be gripped by the gripper jaws on the fingers so that they can actually be lifted. In addition, there is a risk of the objects being crushed and torn. In terms of control technology, safe, non-destructive gripping of flexible, flat objects by means of parallel grippers cannot be implemented or, if at all, only with a disproportionately high effort.

Parallel grippers are mostly designed for gripping rigid objects. The use of suction cups to lift such objects while creating a vacuum for a short time is possible in principle, but this requires additional media lines that generate costs and maintenance and must be routed along the manipulator, usually on the outside, and also restrict the mobility of the robot.

Based on this, it is an objective of the invention to provide an improved gripping device, in particular for robots of lightweight construction, which is easy to operate, versatile in use and, moreover, inexpensive to manufacture and which, in particular, permits the gripping of objects which are mainly flat and inherently flexible in shape.

### SUMMARY

This objective is solved with a gripping device according to the claims as well as with a method according to the claims.

Accordingly, the invention proposes a gripping device for gripping objects, comprising at least two gripping units each having a gripping finger and being transferable by a controlled movement between a release position and a gripping position gripping the object, wherein the gripping units each comprise gripper elements which in the gripping position can be brought into abutment with the object to be gripped, and wherein the gripper elements are rotatably mounted at the distal ends of the gripping fingers.

In particular, the gripping device according to the invention is to be provided for gripping non-fixed or non-rigid objects from a flat base.

Non-rigid objects in the sense of the invention are to be understood here as objects which are inherently pliable or elastic and have a planar extension, such as any kind of textiles, fabric webs, plastic films, paper sheets, insulating materials, and the like.

The gripper elements are provided on the gripping fingers as independent elements, so to speak as a kind of rotary jaws, whereby the rotatable support according to the invention allows that when the gripper elements are in contact with the objects to be gripped, which are usually to be picked up from a flat support, such as for example a conveyor belt, these objects in connection with the support itself act as a kind of abutment against which the gripper elements can roll under intermediate storage or under a clamping of the object.

The force underlying the clamping, i.e., the force with which the gripping fingers are to act on the object or the support via the additional gripper elements, as well as the lateral movement of the gripping fingers towards each other, which leads to a rotational movement of these gripper elements due to the frictional effect between the object and the gripper elements, can be carried out in a preferred manner by an impedance-controlled and therefore sensitive robot, in particular of the lightweight design. The control behavior of such a robot, which can be tuned to this function, enables the non-destructive gripping of soft materials, such as textiles. In particular, the robot is able to “feel” whether the gripper elements are resting appropriately on such an object and whether the object can actually be gripped by means of the gripper elements rotating in the course of the parallel movement of the gripping fingers towards each other.

In one embodiment of the gripping device, the gripper elements are configured to be able to rotate towards each other and away from the object to be gripped when the gripper elements come into contact with each other upon reaching the gripping position.

In a preferred embodiment of the gripping device, the gripper elements have a first section, the outer contour of which is configured with respect to its axis of rotation in such a way that contact between the gripper elements takes place in a linear manner after they have been moved towards each other.

According to the invention, the outer contour of the first section with respect to the axis of rotation therefor partially follows the shape of a mathematical spiral, which is characterized in that the mutual contact point is located above the common plane occupied by the axes of rotation of both gripper elements, such as in an Archimedes spiral.

Furthermore, the gripper elements according to the invention can comprise a second section, the outer contour of which is designed with respect to its axis of rotation in such a way that, when the gripping position is completed, further rotation of the gripper elements is prevented, in particular that, when the gripping position is completed, the gripper elements lie opposite one another at least partially in a planar manner with engagement of the object.

To support a rotational movement when in contact with the object in the intended direction of rotation, the gripper elements may be biased. In addition, the gripper elements may include a device arranged to prevent rotation of the gripper elements when not in contact. This device may further be arranged to cause the gripper elements to rotate away from each other when there is no longer contact between the gripper elements, so as to assist in the release of the gripped object and also to return the gripper elements to their initial position.

A torsion spring in combination with a mechanical stop or similar mechanism is conceivable to ensure that the rotational movement does not start before the gripper elements come into mutual contact, i.e., that accidental rotation is basically prevented, e.g., in the event of a collision with a work surface or the gripped object.

In a further, alternative embodiment according to the invention, at least one of the gripper elements is designed to be rotatably drivable by an actuator. In this way, it is possible, via frictional engagement of the gripper element with the flat object, to displace and thus lift the latter by means of an actively applied rotation relative to, for example, the opposite gripper element, which then serves as an abutment for this purpose.

For this purpose, it is conceivable that the gripping fingers have a gear mechanism for driving the gripper elements, e.g., a belt drive that is guided inside the gripping finger.

In principle, it is advantageous for gripping smooth objects, such as textiles or smooth films, if the outer surface of the gripper elements has a friction-enhancing coating and/or structure, such as a rubber coating, possibly with nubs, lamellae or the like.

The invention also relates to a robot comprising a gripping device according to one of the embodiments described above, preferably of lightweight construction for use in the course of human-robot collaboration (HRC).

In this context, the invention further relates to a control method for gripping a preferably inherently pliant object by means of a robot comprising a gripping device according to one of the embodiments described above, comprising the steps of:
moving the gripping device by the robot towards the object until the gripper elements come to rest on the object;
moving the gripping fingers toward each other until the gripper elements come into mutual contact; and
further moving the gripping fingers toward each other such that the gripper elements are rotated while gripping the object.

Since the gripper elements according to the invention comprise such a shape and such a bearing at the distal ends of the gripping fingers that they automatically rotate towards each other when in contact, a slow linear movement of the gripping fingers towards each other, which can be adjusted depending on the weight of the object to be gripped, is sufficient to pick up the object between the rotating rotary jaws without any great effort. The movement of the gripping fingers towards each other, in particular when the rotary jaws are in contact, can be controlled for impedance for the design with an active drive, this control being correspondingly coordinated with the further control of the robot guiding the gripping device.

The method may comprise the further step of
further moving the gripping fingers towards each other until the gripper elements come into contact with their sections under engagement of the object, which sections are configured not to allow further rotation of the gripper elements.

In particular, the method according to the invention is characterized in that the steps can be carried out by an impedance-controlled and/or sensitively controlled robot, the control of which with respect to the gripping devices to be used is set up accordingly in this respect.

The solutions according to the invention are based on an exploitation of the flexible nature of the object to be gripped. By “pulling” the object between the gripper elements of the fingers of the gripping devices through a rotating, friction-intensive surface, the mechanism ensures correct, above all non-destructive gripping.

To realize the rotary motion, the gripper elements of the robot gripper can pivot around their axes, which are both parallel to each other and parallel to the plane on which the object is located. The outer contour of the respective surface of the gripper elements that comes into contact with the flexible object follows the shape of a mathematical spiral, such as an Archimedean spiral with a contact point located above the common plane of the two axes. As soon as the linear motion of the gripper is activated and the fingers close, the rotating gripper elements or rotary jaws come into contact and the force is exceeded. The mechanical lever causes the rotary jaws to rotate in opposite directions around their respective axes. The object is deformed between the fingers into the support and by controlling the gripping force, a correct grip is ensured. After rotation through a certain angle, preferably half a turn, a flat shaped vertical contact surface is reached and the rotation of the rotary jaws is automatically stopped.

### BRIEF DESCRIPTION OF THE DRAWINGS

Further features and advantages of the invention will become apparent from the description of the embodiments illustrated by the accompanying drawings, in which

FIG. 1 exemplifies a gripping device according to the prior art;

FIGS. 2 to 5 show a first embodiment of a gripping device according to the invention, each figure representing a gripping step of the method according to the invention;

FIG. 6 schematically shows a second embodiment of a gripping device according to the invention; and

FIGS. 7a and 7b exemplarily show a gripping process by means of the second embodiment.

### DETAILED DESCRIPTION

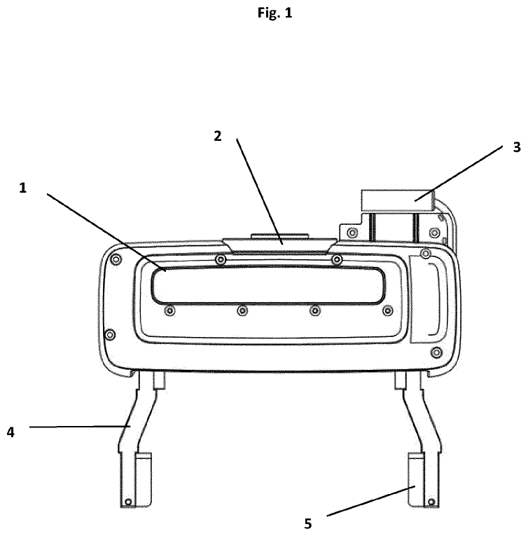

FIG. 1 shows an example of a prior art gripping device that can be attached to a distal end of a multi-link manipulator of an impedance-controlled robot.

The gripping device consists of a base 1, in which a drive mechanism and a guide for the gripping fingers 4 are located, with a flange 2 for attachment to a robot arm, which is not shown, and a connection 3 for controlling the drive of the gripping fingers 4, which can be moved linearly towards each other and comprise gripper jaws 5 at their distal ends. As can be seen, these gripping fingers 4 only permit a parallel grip, with which flat, soft objects, such as textiles, arranged on a flat surface cannot be gripped.

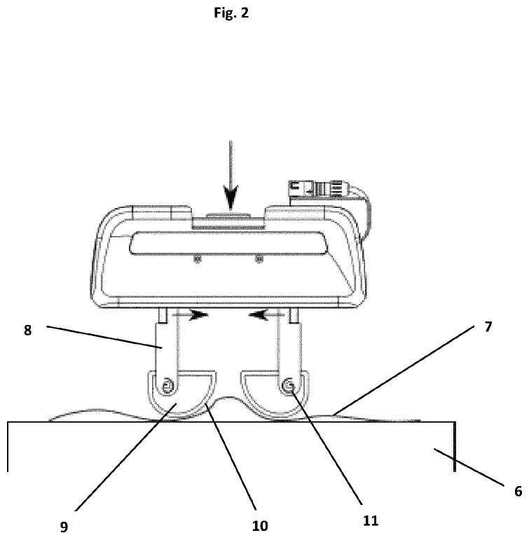

FIGS. 2 to 5 show a first embodiment of a gripping device according to the invention, with which gripping of such objects can be realized in a simple manner.

In FIG. 2, a gripping device is shown in a first embodiment according to the invention, wherein the condition in which the gripping device comes to rest on the flexible object to be gripped is shown, as indicated by the vertical arrow.

The soft and flat object 7 to be gripped, a textile fabric, is placed on a flat support 6.

The gripping device also comprises two gripping fingers 8 that can be moved parallel to each other, as indicated by the horizontal arrows.

At their distal ends, both gripping fingers 8 each comprise a rotatably mounted gripper element in the form of rotary jaws 9, which are provided with a friction-enhancing coating 10 on their outer surface intended to come into contact with the object 7.

In order to prevent the rotary jaws 9 from already starting to rotate when they move towards each other as a result of the parallel movement of the gripping fingers 8, a means 11 is provided which prevents rotation and is designed, for example, as an appropriately dimensioned one-way spring.

As can be seen, movement of the rotary jaws 9 towards each other causes the object 7 to pile up slightly between them due to compression.

By exceeding the force in vertical direction by the robot system (not shown) and closing the rotary jaws 9, the flexible object 7 is already compressed and accumulated between the rotary jaws 9. In this state, the two torsion springs 11 prevent the rotation of the rotary jaws 9.

As can be seen in all FIGS. 2 to 5, the outer contour in a first section 9.1 of the rotary jaws 9 follows the line of an Archimedes spiral, so that as the linear motion progresses, the rotary jaws 9 come into mutual contact at a point K which lies above a common plane formed by the pivot points D of the bearings of the rotary jaws 9.

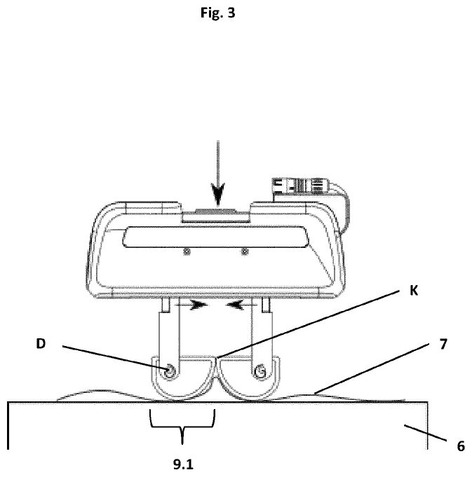

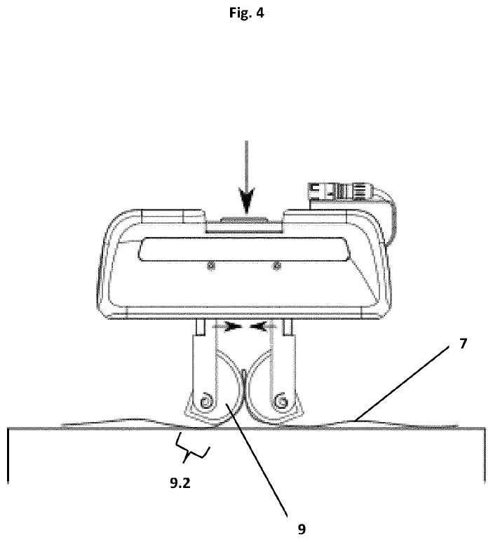

This, according to the invention, as shown in FIG. 3, causes the rotary jaws 9 to begin to rotate as soon as they contact each other at point K, and thereby, as a result of friction and adhesion, more and more material of the object 7 is picked up between the rotary jaws 9 as they continue to rotate and their sections 9.1 roll on each other with intermediate support of the object 7, as shown in FIG. 4, which is induced by further linear movement of the gripping fingers 8 towards each other.

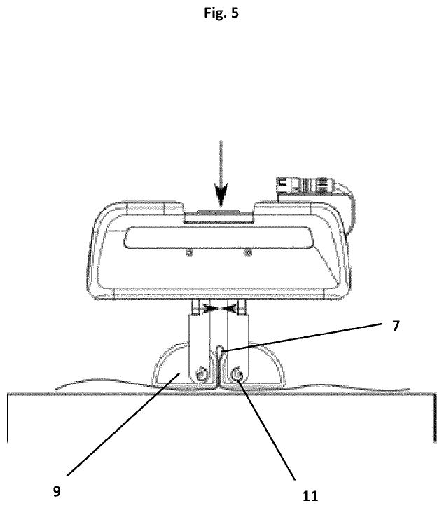

FIG. 5 shows a condition in which the gripping fingers 8 have finally reached their closed position and the rotary jaws 9 have reached their final gripping position. Following their first section 9.1, as seen in the direction of rotation, the rotary jaws 9 comprise a second section 9.2, which is of linear design, as indicated in FIG. 4.

In the final gripping position, these sections 9.2 lie flat opposite each other, enclosing the object 7 at this point. This results in a two-dimensional load with increased frictional engagement, whereby the object 7 can be held securely. In this gripping position, the object 7 can now be lifted by means of the robot and transferred to a target position, where it is then released by the gripping fingers 8 moving apart linearly and the rotary jaws 9 rotating in an opposite direction back to their starting position, if necessary supported by the spring means 11.

The shown mechanism of gripping by the gripping device according to the invention takes advantage of the flexibility of the object 7. It does not rely on precise gripping positions and is therefore more robust against visual errors, for example if additional optical sensors are to be used in conjunction with the robot. Correct and non-destructive gripping of flexible objects of any, preferably planar, design is carried out according to the invention predominantly by force control with respect to the linear movement of the gripping fingers 8.

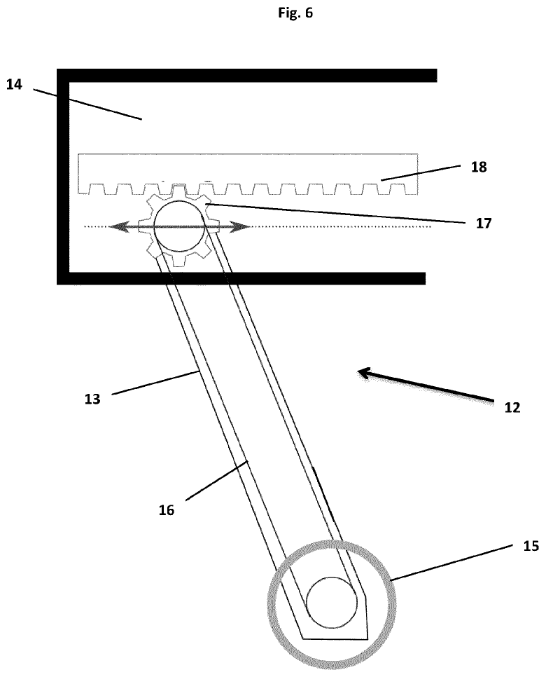

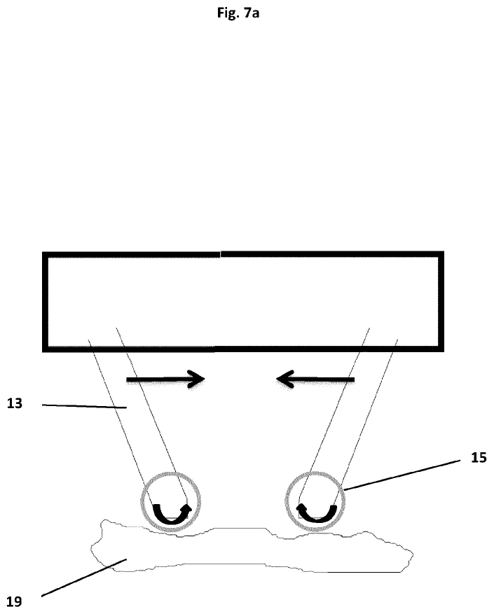

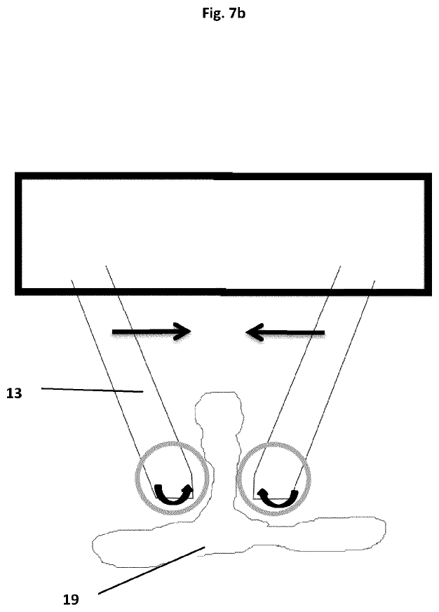

Alternatively, however, it may also be provided that the gripper elements at the distal ends of the gripping fingers are actively actuated. For this purpose, FIGS. 6 to 7b schematically show a second embodiment according to the invention.

Here, a gear and drive mechanism 12 is used, which can be designed in any desired way inside at least one gripping finger 13 and the base 14 of the gripping device.

For example, as shown in FIG. 6, the rotary jaw 15 can be driven by a belt drive 16 arranged inside the gripping finger 13, which in turn is actuated by a gear 17 rolling on a rack 18 inside the base 14, thereby causing it to rotate when the gripping fingers 13 themselves are moved linearly toward or away from each other.

As FIGS. 7a and 7b show, the linear movement of the gripping fingers 13 towards each other and the simultaneous rotary movement of the rotary jaws 15, as indicated in each case by the arrows, causes a flexible object 19 to be accumulated at a corresponding point and to be pulled upwards between the rotary jaws 15 and thereby gripped. This design of the gripping device is suitable for heavier objects 19 of this type, whereby the gripping device as such can also be dimensioned accordingly larger.

Here, too, the advantage is exploited that the object to be gripped has flexible properties. By pulling the object between the rotary jaws of the gripping fingers through a rotating surface with high friction, the mechanism ensures correct and non-destructive gripping. The rotational motion of the rotary jaws 15 is coupled to the linear motion of the gripping fingers 13, so no additional motor is required. The object 19 is deformed between the rotary jaws 15 and the actual gripping force is controlled by the linear motion of the gripping fingers 13. By controlling the distance between the gripping fingers 13, failed gripping attempts can be easily detected and responded to.

The above-described embodiments of a gripping device are particularly suitable for use with an HRC-robot that has a corresponding impedance-control that is capable of implementing such “sensing” gripping of a flat, filigree object, for example, by the gripping device and the robot.

1. A gripping device for gripping objects comprising at least two gripping units each comprising a gripping finger and being transferable by a controlled movement between a release position and a gripping position gripping an object, the gripping units each comprising gripper elements which, in the gripping position, can be brought into contact with the object to be gripped, wherein
the gripper elements are rotatably mounted at distal ends of the gripping fingers.

2. The gripping device according to claim 1, wherein the gripper elements are configured to rotate towards each other and away from the object to be gripped when the gripper elements come into mutual contact upon reaching the gripping position.

3. The gripping device according to claim 2, wherein the gripper elements comprise a first section, an outer contour of which is configured with respect to its axis of rotation in such a way that a contact between the gripper elements takes place linearly.

4. The gripping device according to claim 2, wherein the outer contour of the first section with respect to the axis of rotation (D) partially follows a shape of a mathematical spiral.

5. The gripping device according to claim 3, wherein the gripper elements comprise a second section, an outer contour of which in relation to its axis of rotation is designed in such a way that, when the gripping position is completed, a further rotation of the gripper elements is prevented.

6. The gripping device according to claim 5, wherein, when the gripping position is completed, the gripper elements lie at least partially flat opposite one another with engagement of the object.

7. The gripping device according to claim 1, wherein the gripper elements are biased.

8. The gripping device according to claim 1, wherein the gripper elements comprise means arranged to prevent rotation of the gripper elements when these are not in contact with each other.

9. The gripping device according to claim 8, wherein the device is further adapted to cause the gripper elements to rotate away from each other when there is no longer contact between the gripper elements.

10. The gripping device according to claim 1, wherein at least one of the gripper elements is rotatably drivable.

11. The gripping device according to claim 10, wherein the gripping fingers comprise a gear mechanism for driving the gripper elements.

12. The gripping device according to claim 1, wherein an outer surface of the gripper elements comprises a friction-enhancing coating and/or structure.

13. A robot comprising the gripping device according to claim 1.

14. A method of gripping an object by means of a robot having the gripping device according to claim 1, comprising steps of:
moving the gripping device by the robot towards the object until the gripper elements come to rest on the object;
moving the gripping fingers towards each other until the gripper elements come into mutual contact; and
further moving the gripping fingers towards each other in such a way that the gripper elements are set in rotation while gripping the object.

15. The method according to claim 14, comprising the further a step of:
further moving the gripping fingers towards each other until the gripper elements come into abutment with their sections under engagement of the object, which sections are configured not to allow further rotation of the gripper elements.

16. The method according to claim 14, wherein the steps are performed by an impedance-controlled and/or sensitively controlled robot.
